(19) United States
(12) Patent Application Publication
(10) Pub. No.: US 2025/0175344 A1
(43) Pub. Date: May 29, 2025

(54) DEVICE-BOUND, REPLAY-PROTECTED APPLICATIONS FOR A ROOT OF TRUST

(71) Applicant: Cryptography Research, Inc., San Jose, CA (US)

(72) Inventors: Joel Wittenauer, Pleasanton, CA (US); Matthew E. Orzen, San Francisco, CA (US)

(21) Appl. No.: 18/954,869

(22) Filed: Nov. 21, 2024

Related U.S. Application Data
(60) Provisional application No. 63/602,933, filed on Nov. 27, 2023.

(51) Int. Cl. H04L 9/32; H04L 9/08

(52) U.S. Cl. CPC H04L 9/3242; H04L 9/0861; H04L 9/3247

(57) ABSTRACT

A method for provisioning a device-bound, replay-protected software image may include obtaining, from a provisioning system, a software image and a digital signature associated with the software image. The method may include applying a hash function to the software image and a hash message authentication code (HMAC) to generate a hash of the software image. The HMAC may include an authentication code derived from first data provided by a root of trust (RoT). The first data may include a nonce generated by the RoT or system information associated with the RoT. The method may include verifying, using a public key of the provisioning system, the digital signature. The method may include, responsive to the verification of the digital signature, causing the software image to execute.

### CLAIM OF PRIORTY

The present application claims the benefit under 35 U.S.C. § 119 (e) of U.S. Provisional Patent Application No. 63/602,933 filed Nov. 27, 2023, which is incorporated by reference herein.

### BACKGROUND

The need for secure systems and applications is growing. In some cases, it may be desirable for a secure system to execute a software application only once. It may also be desirable to execute the software application only on a certain computing device or a certain class of computing devices. Conventional devices, however, do not provide such functionality.

### BRIEF DESCRIPTION OF THE DRAWINGS

The present disclosure is illustrated by way of example, and not by way of limitation, in the figures of the accompanying drawings.

FIG. 1 depicts a block diagram of an example system architecture, according to aspects of the present disclosure.

FIG. 2A depicts a sequence diagram of an example flow of data for provisioning and executing a device-bound, replay-protected application for a root of trust, according to aspects of the present disclosure.

FIG. 2B depicts a sequence diagram that continues the example flow of data of FIG. 2A, according to aspects of the present disclosure.

FIG. 2C depicts a sequence diagram that continues the example flow of data of FIG. 2A and FIG. 2B, according to aspects of the present disclosure.

FIG. 3A depicts a sequence diagram of another example flow of data for provisioning and executing a device-bound, replay-protected application for a root of trust, according to aspects of the present disclosure.

FIG. 3B depicts a sequence diagram that continues the example flow of data of FIG. 3A, according to aspects of the present disclosure.

FIG. 4 depicts a flow diagram of an example method for provisioning and executing a device-bound, replay-protected application for a root of trust, according to aspects of the present disclosure.

FIG. 5 depicts a flow diagram of another example method for provisioning and executing a device-bound, replay-protected application for a root of trust, according to aspects of the present disclosure.

FIG. 6 is a block diagram illustrating an exemplary computer system, according to aspects of the present disclosure.

### DETAILED DESCRIPTION

The embodiments described herein describe technologies for provisioning a device-bound, replay-protected application for a root of trust. The following description sets forth numerous specific details, such as examples of specific systems, components, methods, and so forth, in order to provide a good understanding of several implementations of the present disclosure. It will be apparent to one skilled in the art, however, that at least some implementations of the present disclosure may be practiced without these specific details. In other instances, well-known components or methods are not described in detail or presented in simple block diagram format to avoid unnecessarily obscuring the present disclosure. Thus, the specific details set forth are merely examples. Implementations may vary from these example details and still be contemplated to be within the scope of the present disclosure.

In general, it may be desirable on a computing system that a certain event occur only once (sometimes referred to, herein, as the event being “replay-protected”). Additionally or alternatively, it may be desirable that the event occur only on a certain device or a certain class of devices (sometimes referred to, herein, as being “device-bound”). Examples of such an event may include generating a device-unique asset. Generating a device-unique asset may include generating one or more cryptographic keys (e.g., a symmetric key or a public-private key pair), generating a digital certificate, generating a device-unique key, generating a wafer number and its location on the wafer, generating a globally unique identifier (GUID), or generating some other unique asset or information that should only exist on one device. Other events can include enabling the debugging of a program in volatile memory or generating and storing an original equipment manufacturer (OEM) identifier on a device. The replay-protected and/or device-bound event may occur via execution of a software application. Conventionally, systems and devices do not include any type of mechanism for configuring a device-bound and/or replay-protected event or executing the event in a replay-protected and/or device-bound manner.

Aspects of the disclosure address at least the above challenges among others by implementing a system to execute a replay-protected or device-bound event. In particular, a provisioning system may send information about the provisioning system (which may include a nonce generated by the provisioning system) to a root of trust (RoT). The provisioning system may also send cryptographic key information (e.g., an identifier for a symmetric key or a digital certificate that contains a public key). The RoT may use the cryptographic key information to obtain a cryptographic key (e.g., the symmetric key identified by the identifier or the public key contained within the digital certificate) and may use the cryptographic key and the provisioning system information to generate an authentication code key. The ROT may then use the authentication code key, a nonce generated by the RoT, and RoT system information to generate an authentication code. The ROT may also send the RoT nonce and the RoT system information to the provisioning system.

The provisioning system may use the same cryptographic key and provisioning system information (including a provisioning system nonce) to generate an authentication code key that should match the authentication code key generated by the RoT. The provisioning system may use the authentication code key, the received ROT nonce, and the received ROT system information to generate an authentication code that should match the authentication code that the RoT generated. The provisioning system may retrieve a software image. The software image may include an application that is to be replay-protected and/or device-bound. The provisioning system may apply a hash function to the authentication code and the software image to generate a first hash. The provisioning system may digitally sign the first hash using the provisioning system's private key and send the software image, the first hash, and/or the digital signature to the RoT. The RoT may use the received software image, the received first hash, the authentication code the RoT previously generated, and/or other data to verify the received digital signature. If the RoT verifies the digital signature, then the RoT may cause the software image to be executed.

As noted, a technical problem addressed by implementations of the disclosure is that conventional systems do not prevent a repeated execution of a software application or do not prevent execution of the software image on a device for which it may not be desirable for the software image to execute. A technical solution to the above identified technical problems can include performing the operations described above. The use of the RoT's nonce and/or the provisioning system's nonce in generating the authentication code prevents repeated execution of the software image (e.g., because the probability of the RoT being able to regenerate the same nonce is statistically impossible). Similarly, use of the RoT's system information in generating the authentication code prevents execution of the software image on a device other than the RoT.

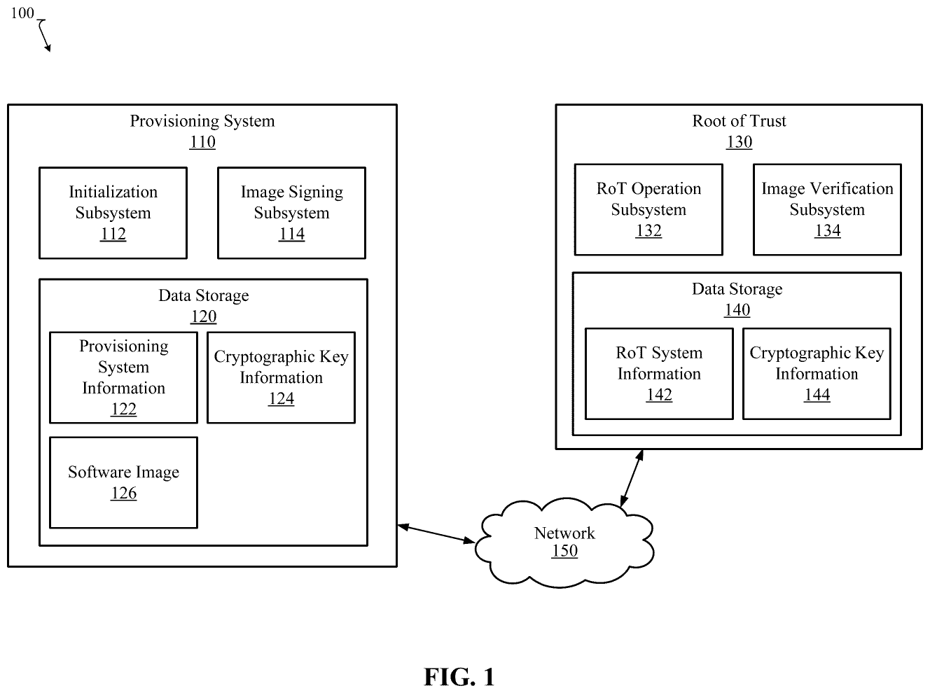

FIG. 1 depicts an illustrative system architecture 100, according to aspects of the present disclosure. Computer system architecture 100 includes a provisioning system 110, a root of trust (RoT) 130, and a network 150. The provisioning system 110 and the RoT 130 are connected to each other in data communication by the network 150.

The provisioning system 110 may include an initialization subsystem 112, an image signing subsystem 114, or a data storage 120. The data storage 120 may include provisioning system information 122, cryptographic key information 124, or a software image 126. The RoT 130 may include an RoT operation subsystem 132, an image verification subsystem 134, or a data storage 140. The data storage 140 may include RoT system information 142 or cryptographic key information 144.

The provisioning system 110 may include one or more computing devices. In some implementations, a computing device may include a physical computing device or may include a virtualized component, such as a virtual machine (VM) or a container. A computing device may include an instance of a computing device. An instance of a computing device may include a spun-up instance that may not be specific to any computing device. In some implementations, a VM may include a system virtual machine, which may include a VM that emulates an entire physical computing device. A VM can include a process virtual machine, which may include a VM that emulates an application or some other software. A container may include a computing environment that logically surrounds one or more software applications independently of other applications executing in the cloud computing environment.

A cloud computing system may include one or more computing devices (or portions of cloud computing devices) provided to an end user by a cloud provider. An end user of the environment may utilize a portion of the cloud computing system to host content for use or access by other parties or perform other computational tasks. In some implementations, the cloud computing system may be configured to allow the end user to use a portion of a computing device (e.g., only certain hardware, software, or other computer system resources). The cloud computing environment may include a private cloud, a public cloud, or a hybrid cloud. The cloud computing environment may provide infrastructure-as-a-service (IaaS), platform-as-a-service (PaaS), or software-as-a-service (SaaS) computing. The cloud computing environment may provide serverless computing.

The initialization subsystem 112 may be configured to perform certain functionality related to provisioning a replay-protected, device-bound software application, as described herein. Such functionality may include retrieving certain provisioning system information 122 or cryptographic key information 124 and sending the retrieved information to the RoT 130, receiving an RoT nonce or ROT system information 142 from the RoT 130, generating authentication code keys and authentication codes, and other functionality described herein. The initialization subsystem 112 may include software, hardware, or a combination of software and hardware.

The image signing subsystem 114 may be configured to perform certain functionality related to provisioning a replay-protected, device-bound software application 126, as described herein. Such functionality may include generating a hash of a software image 126 and authentication code, digitally signing the hash, and other functionality described herein. The image signing subsystem 114 may include software, hardware, or a combination of software and hardware.

The data storage 120 may be hosted by one or more data storage devices. A data storage device may include volatile storage or nonvolatile storage. The data storage 120 may include main memory, magnetic or optical storage-based disks, tapes or hard drives, network-attached storage (NAS), a storage area network (SAN), or the like. In some implementations, the data storage 120 may include a network-attached file server, an object-oriented database, a relational database, or the like. The data storage 120 may be hosted by a cloud-based environment or one or more different machines coupled to the cloud-based environment. In some implementations, the data storage 120 may include a data storage device hosted on an external computing device, e.g., a computing device other than the provisioning system 110 that is still in data communication with the provisioning system 110 (e.g., over the network 150).

The provisioning system information 122 may include information about the provisioning system 110. The provisioning system information 122 may include a nonce generated by the provisioning system 110 (e.g., generated by the initialization subsystem 112), an Internet Protocol (IP) address of the provisioning system 110, a media access control (MAC) address of the provisioning system 110, a device name of a computing device of the provisioning system 110, an OEM identifier of a computing device of the provisioning system 110, or the like.

The cryptographic key information 124 may include data about one or more cryptographic keys used by the provisioning system 110. The cryptographic key information 124 may include a symmetric key shared by the provisioning system 110 and the RoT 130 (which may have been previously provisioned to each of the provisioning system 110 and the RoT 130), a public-private key pair used by the provisioning system 110, or other cryptographic key information. In some implementations, a hardware security module or other key management and cryptographic accelerator of the provisioning system 110 may manage some of the cryptographic key information 124. Some of the cryptographic key information 124 may be stored in the provisioning system's 110 nonvolatile memory or a netlist of the provisioning system 110.

The software image 126 may include a software application. The software application may include an application for which it may be desirable that the application is replay-protected and/or device-bound. The software image 126 may include the software application, metadata associated with the software application, or other data and settings associated with the software application. In some embodiments, the software image 126 may include a container that may include a computing environment that logically surrounds the software application independently of other applications executing on the same computing device.

The software image 126 may include a software application configured to write an OEM identifier to an electronic device. The software image 126 may include debugging enablement. The software image 126 may include a cryptographic key-generating software application. The software image 126 may include some other software application that is to be replay-protected or device-bound.

The RoT 130 may include one or more computing devices. A computing device of the RoT 130 may include cryptographic functions that may enable a secure boot process of the computing device. The RoT 130 may include a stand-alone security module or may include a security module implemented on a processor or system on a chip (SoC). The RoT 130 may include a fixed function ROT, which may include firmware-controlled execution. The RoT 130 may include a programmable ROT, which may include a central processing unit-(CPU-) controlled execution. In some implementations, the RoT 130 may be configured to execute certain operations within a dedicated security domain, such operations may include cryptographic operations such as encrypting or decrypting data, generating or validating a digital certificate, or managing cryptographic keys.

The RoT operation subsystem 132 may be configured to perform certain functionality related to provisioning a replay-protected, device-bound software application, as described herein. Such functionality may include using a cryptographic key and provisioning system information 122 to generate an authentication code key, generating a nonce, using the authentication code key, the nonce, and the RoT system information 142 to generate an authentication code, and other functionality described herein. The RoT operation subsystem 132 may include software, hardware, or a combination of software and hardware.

The image verification subsystem 134 may be configured to perform certain functionality related to verifying a replay-protected, device-bound software application, as described herein. Such functionality may include generating a hash of an authentication code and a software image 126, verifying a digital signature of the software image 126, and/or causing the software image 126 to be executed. The image verification subsystem 134 may include software, hardware, or a combination of software and hardware.

The data storage 140 of the RoT 130 may be similar to the data storage 120 of the provisioning system 110. The RoT system information 142 may include information about the RoT 130. The RoT system information 142 may include a nonce generated by the RoT 130 (e.g., generated by the RoT operation subsystem 132), an IP address of the RoT 130, a MAC address of the RoT 130, a device name of a computing device of the RoT 130, an OEM identifier of a computing device of the RoT 130, or the like. At least a portion of the data storage 140 may be located on a computing device external to the ROT 130.

The cryptographic key information 144 of the data storage 140 of the RoT 130 may include data about one or more cryptographic keys used by the RoT 130. The cryptographic key information 144 may include a symmetric key shared by the provisioning system 110 and the RoT 130 (which may have been previously provisioned to each of the provisioning system 110 and the RoT 130), a public-private key pair used by the RoT 130, or other cryptographic key information. In some implementations, the RoT 130 may manage some of the cryptographic key information 144. Some of the cryptographic key information 144 may be stored in the RoT's 130 nonvolatile memory or a netlist of the ROT 130.

The network 150 may include a public network (e.g., the Internet), a private network (e.g., a local area network (LAN) or wide area network (WAN)), or a combination thereof. The network 150 may include a wireless infrastructure, which may be provided by one or more wireless communications systems, such as a wireless fidelity (Wi-Fi) hotspot connected with the network 150 or a wireless carrier system that may be implemented using various data processing equipment, communication towers, etc. Additionally, or alternatively, the network 150 may include a wired infrastructure (e.g., Ethernet). In some implementations, the provisioning system 110 and the RoT 130 may reside on the same computing device and, thus, the architecture 100 may not include the network 150. The provisioning system 110 and the RoT 130 may be in data communication over a bus or some other intra-computing device communication channel.

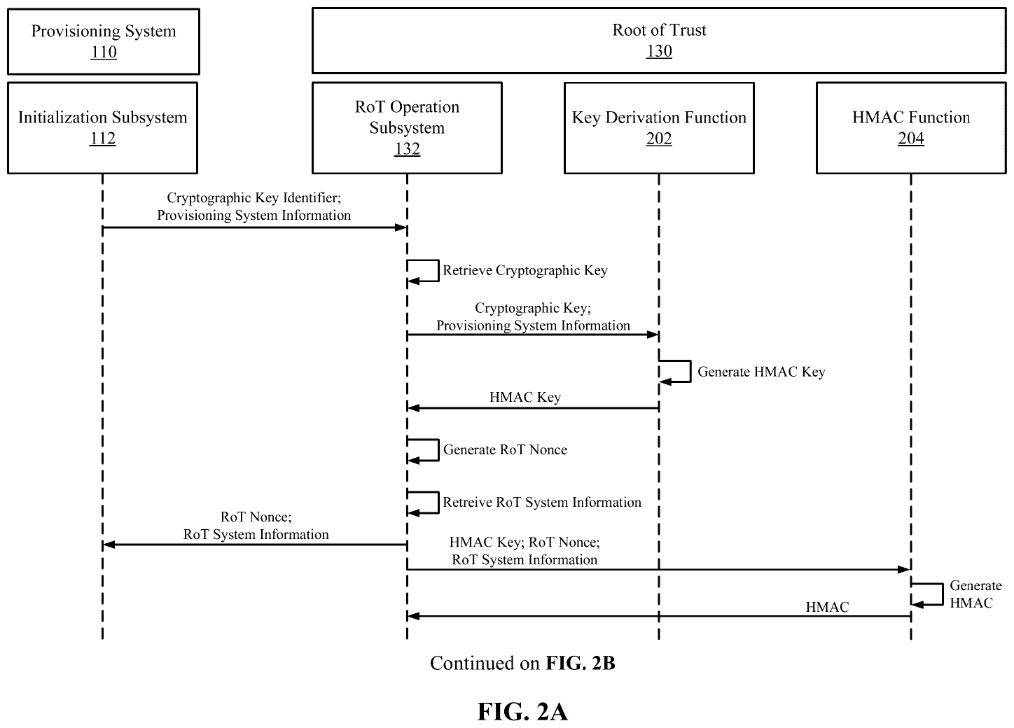

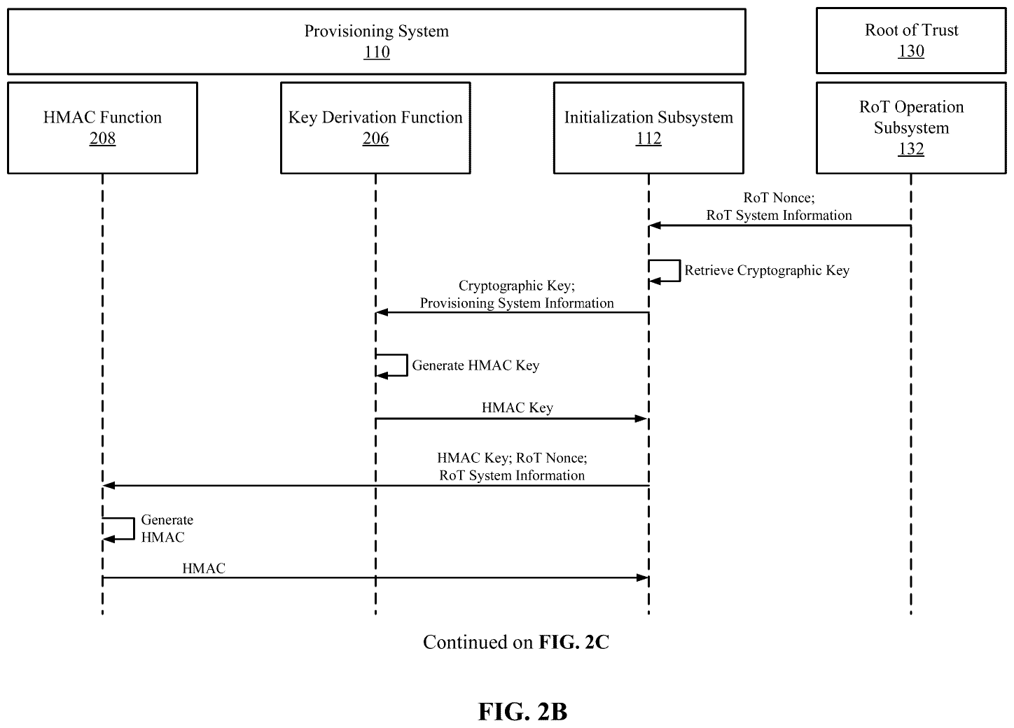

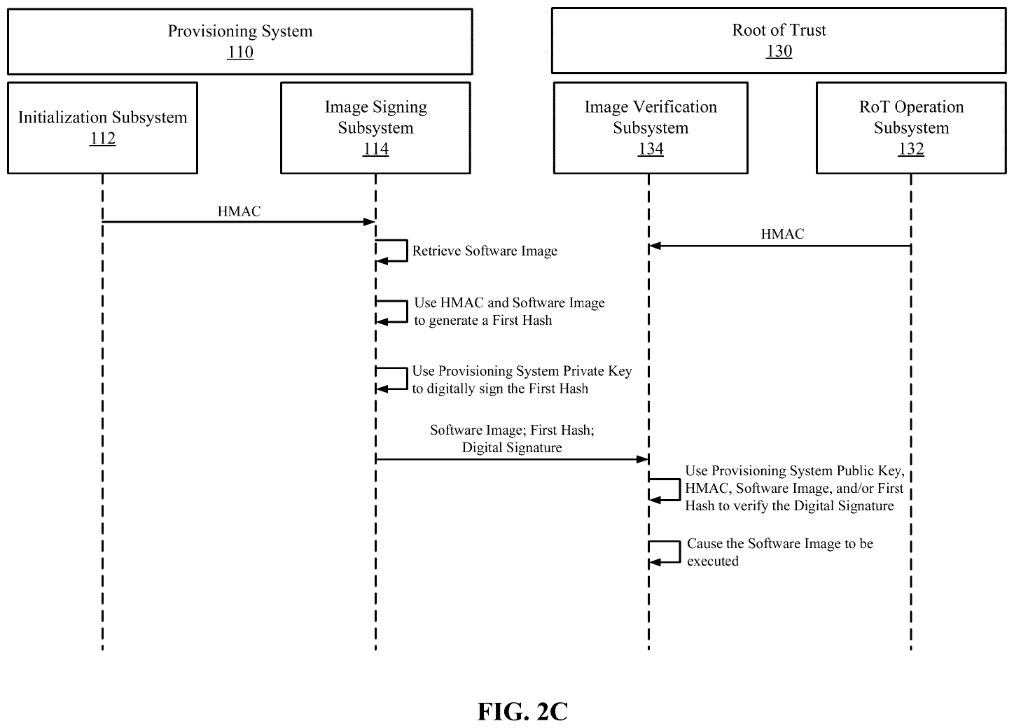

FIGS. 2A through 2C illustrate an example sequence diagram that shows operations performed by components of the architecture 100 and shows data flow between the components. The example sequence diagram may illustrate a process for configuring a software image 126 to be replay-protected or device-bound and a process for determining whether to execute the replay-protected or device-bound software image 126. It should be noted that the operations depicted in FIGS. 2A through 2C may occur in a different order than as shown in these figures. Some operations may occur concurrently. Some operations may be performed by components other than as shown in the figures.

As seen in FIG. 2A, the initialization subsystem 112 may provide a cryptographic key identifier and a portion of the provisioning system information 122 to the RoT operation subsystem 132. The initialization subsystem 112 may provide this data to the RoT operation subsystem 132 over the network 150. The cryptographic key identifier may include data that allows the RoT operation subsystem 132 to identify a symmetric cryptographic key stored in the cryptographic key information 144. The portion of the provisioning system information 122 may include at least a portion of the provisioning system information 122 stored by the provisioning system 110. The initialization subsystem 112 may provide the cryptographic key identifier and the portion of the provisioning system information 122 to the RoT operation subsystem 132 as part of a start command, which may alert the RoT 130 that the RoT 130 is being requested to carry out a process to configure a replay-protected or device-bound software image.

The RoT operation subsystem 132 may retrieve the cryptographic key identified by the cryptographic key identifier from the cryptographic key information 144. The RoT operation subsystem 132 may provide the cryptographic key and the received portion of the provisioning system information 122 to a key derivation function 202. The key derivation function 202 may reside on the RoT 130. The key derivation function 202 may be configured to accept input data and generate a key based on the input data. The key derivation function 202 may be deterministic and, thus, identical inputs may result in identical keys as output. The key derivation function 202 may use the cryptographic key and the received portion of the provisioning system information 122 as input and generate an HMAC key as an output. The key derivation function 202 may provide the HMAC key to the RoT operation subsystem 132.

The RoT operation subsystem 132 may generate a nonce (“ROT nonce”). The ROT operation subsystem 132 may retrieve a portion of the RoT system information 142. The RoT operation subsystem 132 may provide the ROT nonce and the portion of the ROT system information 142 to the provisioning system 110 (e.g., the initialization subsystem 112) over the network 150. The RoT operations subsystem 132 may provide the HMAC key, the RoT nonce, and the portion of the RoT system information 142 to an HMAC function 204. The HMAC function 204 may be configured to accept input data and generate an authentication code based on the input data. The HMAC function 204 may reside on the RoT 130. The HMAC function 204 may be deterministic. The HMAC function 204 may use the HMAC key, the ROT nonce, and the portion of the RoT system information 142 as input and generate an HMAC as an output. The HMAC function 204 may provide the HMAC to the RoT operation subsystem 132.

In some implementations, in response to receiving the HMAC, the RoT operation subsystem 132 may delete the RoT nonce. This may prevent the ROT nonce from being used again and may help provide the replay-protected characteristic of the software image 126.

As seen in FIG. 2B, the initialization subsystem 112 of the provisioning system 110 may receive the RoT nonce and the portion of the ROT system information 142. The initialization subsystem 112 may retrieve, from the cryptographic key information 124, the cryptographic key indicated by the cryptographic key identifier. The initialization subsystem 112 may provide the retrieved cryptographic key and a portion of the provisioning system information 122. The portion of the provisioning system information 122 may be the same portion that the initialization subsystem 112 previously provided to the RoT operation subsystem 132.

The initialization subsystem 112 may provide the cryptographic key and the portion of the provisioning system information 122 to a key derivation function 206. The key derivation function 206 of the provisioning system 110 may be similar or identical to the key derivation function 202 of the RoT 130. The key derivation function 206 may use the cryptographic key and the portion of the provisioning system information 122 as input and may generate an HMAC key as output. Because the cryptographic key, the portion of the provisioning system information 122, and the key derivation function 206 operations should match the cryptographic key, the portion of the provisioning system information 122, and the key derivation function 202 operations used by the RoT 130, the HMAC key generated by the key derivation function 206 should match the HMAC key generated by the key derivation function 202. The key derivation function 206 may provide the HMAC key to the initialization subsystem 112.

The initialization subsystem 112 may provide the HMAC key, the ROT nonce, and the portion of the ROT system information 142 to an HMAC function 208. The HMAC function 208 of the provisioning system 110 may be similar or identical to the HMAC function 204 of the ROT 130. The HMAC function 208 may use the HMAC key, the RoT nonce, and the portion of the RoT system information 142 as input and may generate an HMAC as output. Because the HMAC key, the RoT nonce, the portion of the ROT system information 142, and the HMAC function 208 operations should match the HMAC key, the ROT nonce, the portion of the RoT system information 142, and the HMAC function 204 operations used by the RoT 130, the HMAC generated by the HMAC function 208 should match the HMAC generated by the HMAC function 204. The HMAC function 208 may provide the HMAC to the initialization subsystem 112.

In some implementations, in response to receiving the HMAC, the initialization subsystem 112 may delete the ROT nonce. This may prevent the ROT nonce from being used again and may help provide the replay-protected characteristic of the software image 126.

As seen in FIG. 2C, the initialization subsystem 112 may provide the HMAC to the image signing subsystem 114. The image signing subsystem 114 may retrieve the software image 126 from the data storage 120. The image signing subsystem 114 may provide the HMAC and the software image 126 to a hash function (not shown in FIG. 2C). The image signing subsystem 114 may apply a hash function to the HMAC and the software image 126 to generate a first hash. The image signing subsystem 114 may retrieve a private key of the provisioning system 110 (e.g., from the cryptographic key information 124) and digitally sign the first hash using the private key. The image signing subsystem 114 may send the software image 126, the first hash, and the digital signature to the image verification subsystem 134 of the RoT 130. The image signing subsystem 114 may send the software image 126 and the digital signature as part of an execution command, which may alert the RoT 130 that the RoT 130 is being requested to carry out a process to cause execution of a replay-protected or device-bound software image 126.

The image verification subsystem 134 may obtain the HMAC from the RoT operation subsystem 132. The image verification subsystem 134 may receive the software image 126, the first hash, and the digital signature from the image signing subsystem 114. The image verification subsystem 134 may apply a hash function to the HMAC and the software image 126 to generate a second hash. The image verification subsystem 134 may retrieve a public key of the provisioning system 110. The public key may form part of a public-private key pair with the private key of the provisioning system 110 that was used to digitally sign the first hash. The image verification subsystem 134 may use the public key, the software image 126, the first hash, the second hash, and/or other data, to verify the digital signature. Verifying the digital signature may indicate that the first hash came from the provisioning system 110.

Responsive to image verification subsystem 134 verifying the digital signature, the image verification subsystem 134 can determine that the RoT 130 has not previously caused the execution of the software image 126 (replay-protection) or that the RoT 130 is the device authorized to cause the execution of the software image (device-bound). If the same software image 126 and digital signature were provided to a different ROT, the different ROT would be incapable of generating a matching HMAC because generating the HMAC is based on the ROT system information 142, and the RoT system information for the different ROT would be different than the authorized RoT 130. Similarly, if the same software image 126 and digital signature were provided to the RoT 130 again, the RoT 130 would generate a different HMAC because the HMAC is based on the ROT nonce the RoT 130 generated the first time it generated the HMAC, and it is highly improbable that the RoT 130 would generate a matching ROT nonce a second time.

In some implementations, verifying the digital signature may include the image verification subsystem 134 comparing the first hash (which the image signing subsystem 114 generated) to the second hash (which the image verification subsystem 134 generated) to determine if the two hashes match. Verifying the digital signature may include other operations.

Responsive to the image verification subsystem 134 verifying the digital signature, the image verification subsystem 134 may cause the execution of the software image 126. In some implementations, the RoT 130 may execute the software image 126. In other implementations, the RoT 130 may provide the software image 126 to another component or computing device to execute the software image 126.

In some implementations, the provisioning system 110 and the RoT 130 may use an asymmetric key architecture in generating the HMAC key. The provisioning system 110 and the RoT 130 may use this asymmetric key architecture instead of a symmetric cryptographic key that may have been pre-provisioned to the provisioning system 110 and the ROT 130.

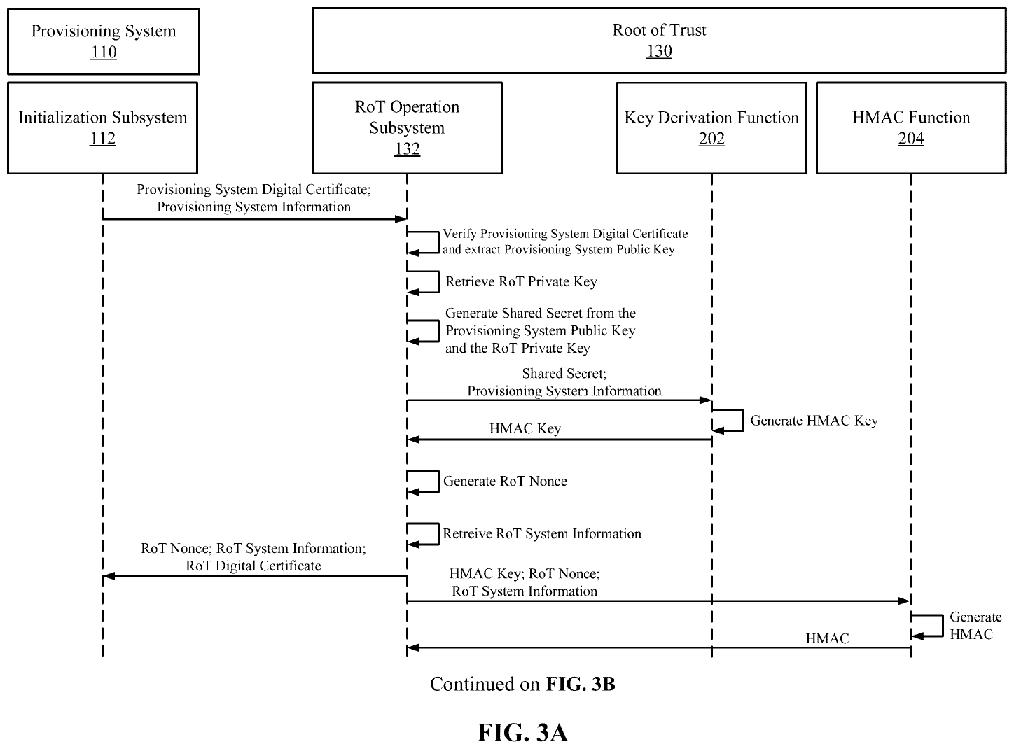

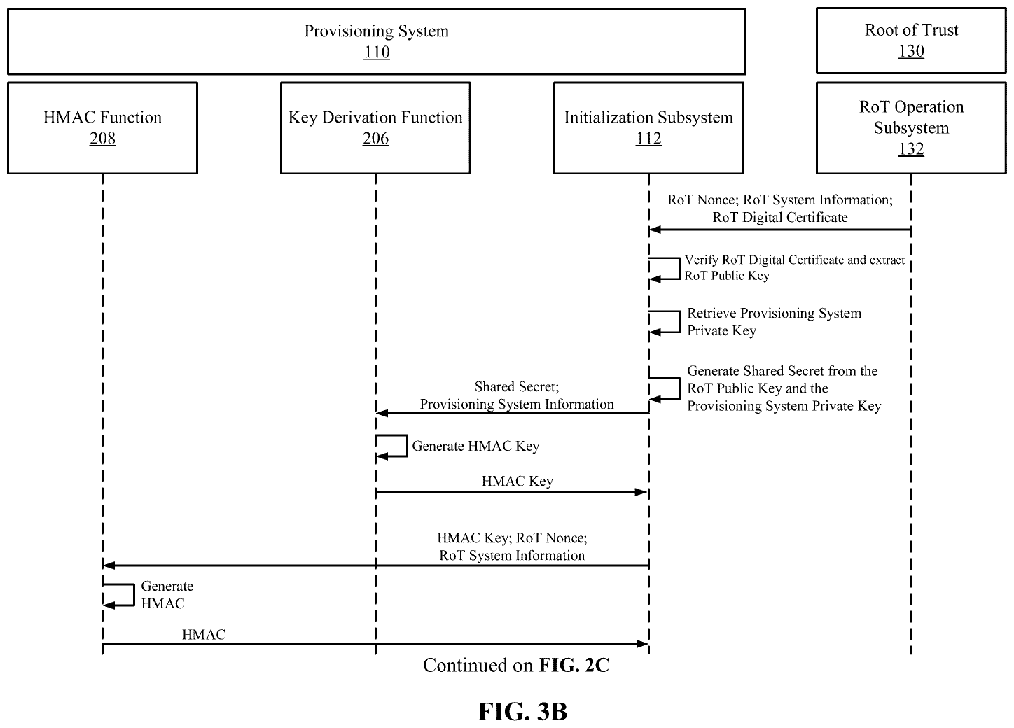

FIG. 3A and FIG. 3B illustrate an example sequence diagram that show operations performed by components of the architecture 100 and show data flow between the components. The example sequence diagram may illustrate a process for configuring a software image 126 to be replay-protected or device-bound using an asymmetric key architecture. It should be noted that the operations depicted in FIGS. 3A and 3B may occur in a different order than as shown in these figures. Some operations may occur concurrently. Some operations may be performed by components other than as shown in the figures.

As seen in FIG. 3A, the initialization subsystem 112 may provide a provisioning system digital certificate and a portion of the provisioning system information 122 to the RoT operation subsystem 132. The provisioning system digital certificate may include a digital certificate generated by or for the provisioning system 110. The digital certificate may include a first provisioning system public key. The first provisioning system public key may include a public key used by the provisioning system 110 and may, with a first provisioning system private key, form a first provisioning system public-private key pair. The initialization subsystem 112 may provide the provisioning system digital certificate and the portion of the provisioning system information 122 to the RoT operation subsystem 132 as part of a start command, which may alert the RoT 130 that the RoT 130 is being requested to carry out a process to configure a replay-protected or device-bound software image 126.

The RoT operation subsystem 132 may obtain the provisioning system digital certificate and the portion of the provisioning system information 122. The RoT operation subsystem 132 may verify the provisioning system digital certificate. Verifying the digital certificate may include the RoT operation subsystem 132 verifying the digital certificate's validity, which may include determining that the digital certificate is not expired, that the certificate authority (CA) that issued the digital certificate has not revoked the digital certificate, that the CA is trusted, etc. Verifying the digital certificate may include the RoT operation subsystem 132 verifying the digital signature of the issuing CA that is included in the digital certificate. Verifying the digital certificate may include the RoT operation subsystem 132 verifying the digital certificate's chain of trust. Responsive to the RoT operation subsystem 132 verifying the provisioning system digital certificate, the RoT operation subsystem 132 may extract the first provisioning system public key from the digital certificate.

The RoT operation subsystem 132 may retrieve a first ROT private key from the cryptographic key information 144. The first ROT private key may include a private key used by the RoT 130 and may, with a first ROT public key, form a first ROT public-private key pair. The RoT operation subsystem 132 may generate a shared secret based on the first provisioning system public key and the first ROT private key. Generating the shared secret may include using a key agreement protocol with the first provisioning system public key and the first ROT private key as inputs and the key agreement protocol generating the shared secret. The key agreement protocol may include a Diffie-Hellman (DH) key exchange, elliptic-curve Diffie-Hellman (ECDH), elliptic curve integrated encryption scheme (ECIES), perfect forward secrecy (PFS), etc.

The RoT operation subsystem 132 may provide the shared secret and the received portion of the provisioning system information 122 to the key derivation function 202. The key derivation function 202 may use the shared secret and the received portion of the provisioning system information 122 as input and generate the HMAC key as an output. The key derivation function 202 may provide the HMAC key to the RoT operation subsystem 132.

The RoT operation subsystem 132 may generate the RoT nonce and may retrieve a portion of the RoT system information 142. The RoT operation subsystem 132 may provide the RoT nonce, the portion of the RoT system information 142, and an RoT digital certificate to the provisioning system 110 (e.g., the initialization subsystem 112) over the network 150. The RoT operations subsystem 132 may provide the HMAC key, the ROT nonce, and the portion of the RoT system information 142 to the HMAC function 204. The HMAC function 204 may use the HMAC key, the RoT nonce, and the portion of the RoT system information 142 as input to generate an HMAC as an output. The HMAC function 204 may provide the HMAC to the RoT operation subsystem 132.

As seen in FIG. 3B, the initialization subsystem 112 of the provisioning system 110 may receive the RoT nonce, the portion of the ROT system information 142, and the ROT digital certificate. The RoT digital certificate may include the first ROT public key. As discussed above, the first ROT public key and the first ROT private key (i.e., the ROT private key the RoT operation subsystem 132 used to generate the shared secret) may form the first ROT public-private key pair. The initialization subsystem 112 may verify the RoT digital certificate. Responsive to the initialization subsystem 112 verifying the RoT digital certificate, the initialization subsystem 112 may extract the first ROT public key from the digital certificate.

The initialization subsystem 112 may retrieve the first provisioning system private key from the cryptographic key information 124. As discussed above, the first provisioning system private key and the first provisioning system public key (i.e., the provisioning system public key that was included in the provisioning system digital certificate that the initialization subsystem 112 sent to the RoT 130) may form the first provisioning system public-private key pair. The initialization subsystem 112 may generate a shared secret based on the first ROT public key and the first provisioning system private key. Generating the shared secret may include using a key agreement protocol with the first ROT public key and the first provisioning system private key as inputs and the key agreement protocol generating the shared secret. The shared secret generated at the initialization subsystem 112 should match the shared secret generated at the RoT operations subsystem 132 because of the use of the key agreement protocol by both of the initialization subsystem 112 and the RoT operation subsystem 132.

The initialization subsystem 112 may provide the shared secret and the portion of the provisioning system information 122 to a key derivation function 206. The key derivation function 206 of the provisioning system 110 may be similar or identical to the key derivation function 202 of the RoT 130. The key derivation function 206 may use the shared secret and the portion of the provisioning system information 122 as input and may generate an HMAC key as output. Because the shared secret, the portion of the provisioning system information 122, and the key derivation function 206 operations should match the shared secret, the portion of the provisioning system information 122, and the key derivation function 202 operations used by the RoT 130, the HMAC key generated by the key derivation function 206 should match the HMAC key generated by the key derivation function 202. The key derivation function 206 may provide the HMAC key to the initialization subsystem 112.

The initialization subsystem 112 may provide the HMAC key, the RoT nonce, and the portion of the ROT system information 142 to an HMAC function 208. The HMAC function 208 of the provisioning system 110 may be similar or identical to the HMAC function 204 of the RoT 130. The HMAC function 208 may use the HMAC key, the ROT nonce, and the portion of the RoT system information 142 as input and may generate an HAMC as output. Because the HMAC key, the RoT nonce, the portion of the RoT system information 142, and the HMAC function 208 operations should match the HMAC key, the ROT nonce, the portion of the RoT system information 142, and the HMAC function 204 operations used by the RoT 130, the HMAC generated by the HMAC function 208 should match the HMAC generated by the HMAC function 204. The HMAC function 208 may provide the HMAC to the initialization subsystem 112.

The sequence shown in FIGS. 3A and 3B may continue at FIG. 2C. The initialization subsystem 112 may send the HMAC to the image signing subsystem 114. The image signing subsystem 114 may retrieve the software image 126 and may apply a hash function to the HMAC and the software image 126 to generate the first hash. The image signing subsystem 114 may use a second provisioning system private key to digitally sign the first hash. The second provisioning system private key may be the first provisioning system private key (i.e., the private key that the initialization subsystem 112 used to generate the shared secret) or may be a different cryptographic key. The image signing subsystem 114 may provide the software image 126 and the digital signature to the RoT 130.

The image verification subsystem 134 of the RoT 130 may receive the software image 126, the first hash, and/or the digital signature. The image verification subsystem 134 may use a second provisioning system public key to verify the digital signature. The second provisioning system public key and the second provisioning system private key may form a second provisioning system public-private key pair. Responsive to the image verification subsystem 134 verifying the digital signature, the image verification subsystem 134 can determine that the RoT 130 has not previously caused the execution of the software image 126 (replay-protection) or that the RoT 130 is the device authorized to cause the execution of the software image (device-bound). Responsive to verifying the digital signature, the image verification subsystem 134 may cause the execution of the software image 126. In some implementations, the RoT 130 may execute the software image 126. In other implementations, the RoT 130 may provide the software image 126 to another component or computing device to execute the software image 126.

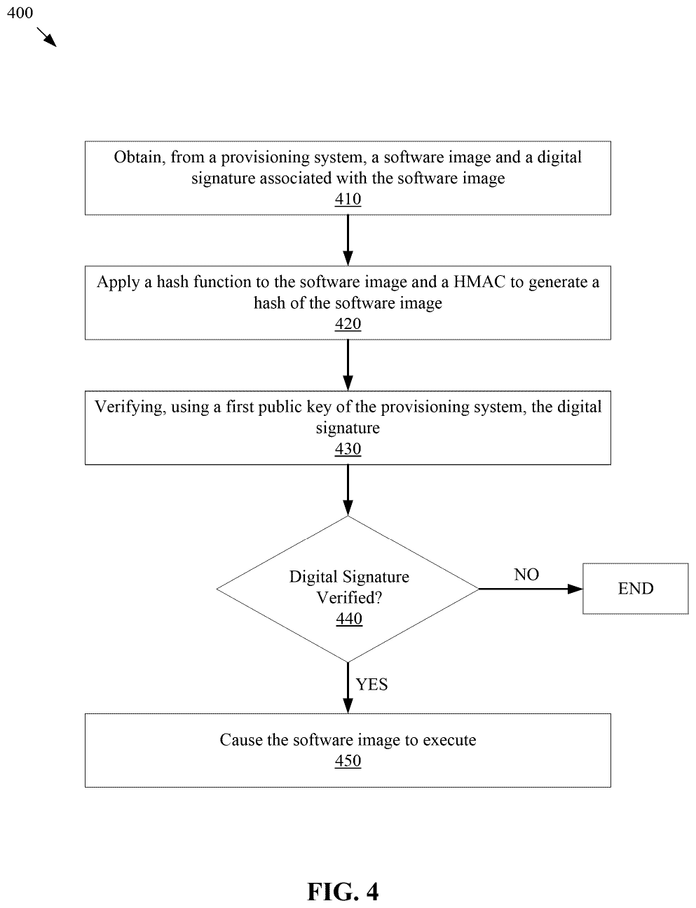

FIG. 4 depicts a flow diagram of an example method 400 for verifying a replay- protected, device-bound software image 126, in accordance with some implementations of the disclosure. The individual functions, routines, subroutines, or operations of the method 400 may be performed by a processing device, having one or more CPU(s) and memory devices communicatively coupled to the CPU(s). In some implementations, the method 400 may be performed by a single processing thread or alternatively by two or more processing threads, each thread executing one or more individual functions, routines, subroutines, or operations of the method. The method 400 as described below may be performed by processing logic that may include hardware (e.g., a processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the operations may be modified. Thus, the illustrated implementations should be understood only as examples, and the illustrated operations may be performed in a different order, while some operations may be performed in parallel. Additionally, one or more operations may be omitted in some implementations. Thus, not all illustrated operations are required in every implementation, and other process flows are possible. In some implementations, the same, different, fewer, or greater operations may be performed. It is noted that elements of FIG. 1 may be used herein to help describe FIG. 4. In some implementations, the image verification subsystem 134 of the RoT 130 may perform one or more of the operations of the method 400.

At operation 410 of method 400, processing logic may obtain, from the provisioning system 110, a software image 126, a first hash, and/or a digital signature associated with the software image 126. The software image 126 may include a software application for which it is desirable for the application to be replay-protected or device-bound. The first hash may include the first hash generated by the image signing subsystem 114 applying the HMAC and the software image 126 to the hash function. Operation 410 may include the image signing subsystem 114 providing the software image 126, the first hash, and the digital signature, as shown in FIG. 2C and/or as described above.

At operation 420, processing logic may apply a hash function to the software image 126 and a hash message authentication code (HMAC) to generate a second hash of the software image 126. The HMAC may include an authentication code derived from first data provided by the RoT 130. Operation 420 may include the image verification subsystem 134 applying a hash function to the HMAC and the software image 126 and obtaining the second hash as output of the hash function, as shown in FIG. 2C and as described above. The first data may include a first nonce generated by the RoT 130. The first nonce may include the ROT nonce, as shown in FIG. 2B and described above. The first data may include ROT system information 142, which may include the portion of ROT system information 142, as shown in FIG. 2B and discussed above.

In some implementations, the software image 126 may be encrypted. The software image 126 may be encrypted so that the software image 126 cannot be viewed, accessed, or used by an intercepting party, e.g., while the software image 126 is in transit over the network 150. The software image 126 may have been encrypted by a symmetric cryptographic key shared by the provisioning system 110 and the RoT 130, and which may be the same as or different from the symmetric key identified by the cryptographic key identifier discussed above in regards to FIG. 2A. The software image 126 may have been encrypted using encryption operations established between the provisioning system 110 and the RoT 130 (e.g., a shared key, a key derived by each of the provisioning system 110 and the RoT 130, or some other operation). The method 400 may further include decrypting the encrypted software image 126.

At operation 430, processing logic may verify, using a first public key of the provisioning system 110, the digital signature. Operation 430 may include the image verification subsystem 134 retrieving a public key of the provisioning system 110 and using the public key to verify the digital signature obtained in operation 410.

At operation 440, responsive to the verification of the digital signature in operation 430, processing logic may move to operation 450, at which processing logic may cause the software image 126 to execute. This may include, as shown in FIG. 2C and as described above, the image verification subsystem 134 causing the software image 126 to be executed. Responsive to the digital signature not being verified, processing logic may end the method 400, and the software image 126 may not execute. In some implementations, causing the software image 126 to be executed may include executing the software image in the RoT 130.

In some embodiments, the method 400 may further include the operation of sending the first data to the provisioning system 110. As discussed above, the HMAC may include an authentication code derived from first data provided by the RoT 130, and the first data may include the RoT nonce or a portion of the ROT system information 142. The RoT 130 may send this first data to the provisioning system 110, for example, as shown in FIG. 2B. In some implementations, this operation may occur prior to operation 410.

In one or more implementations, the method 400 may further include the operation of obtaining, from the provisioning system 110, second data provided by the provisioning system 110. The second data may include a cryptographic key identifier. The second data may include a second nonce, which may include a nonce generated by the provisioning system 110. The second data may include provisioning system information, which may include the portion of the provisioning system information 122. Obtaining the second data may include, as shown in FIG. 2A and discussed above, the initialization subsystem 112 sending the cryptographic key identifier and the portion of the provisioning system information 122 to the RoT operation subsystem 132. The operation may further include generating an HMAC key derived from at least a portion of the second data and generating, based on the HMAC key and the first data, the HMAC. This may include, as shown in FIG. 2A and discussed above, the RoT operation subsystem 132 using the portion of the provisioning system information 122 as input to the key derivation function 202 to generate the HMAC key and using the ROT nonce and the portion of the RoT system information 142 as input to the HMAC function 204 to generate the HMAC. In some implementations, generating the HMAC key may include obtaining the cryptographic key indicated by the cryptographic key identifier and inputting the cryptographic key and the at least a portion of the second data into the key derivation function 202.

In some implementations, the second data may include a digital certificate that includes a second public key of the provisioning system. Generating the HMAC key may include using the second public key to compute a shared secret with the provisioning system and inputting the shared secret and the at least a portion of the second data into a key derivation function. As discussed above, in relation to FIG. 3A, the RoT operation subsystem 132 may receive a digital certificate from the initialization subsystem 112. The digital certificate may include the first provisioning system public key. The RoT operation subsystem 132 may use a key agreement protocol with the first ROT private key and the first provisioning system public key to generate the shared secret, which the RoT operation subsystem 132 may use to generate the HMAC key.

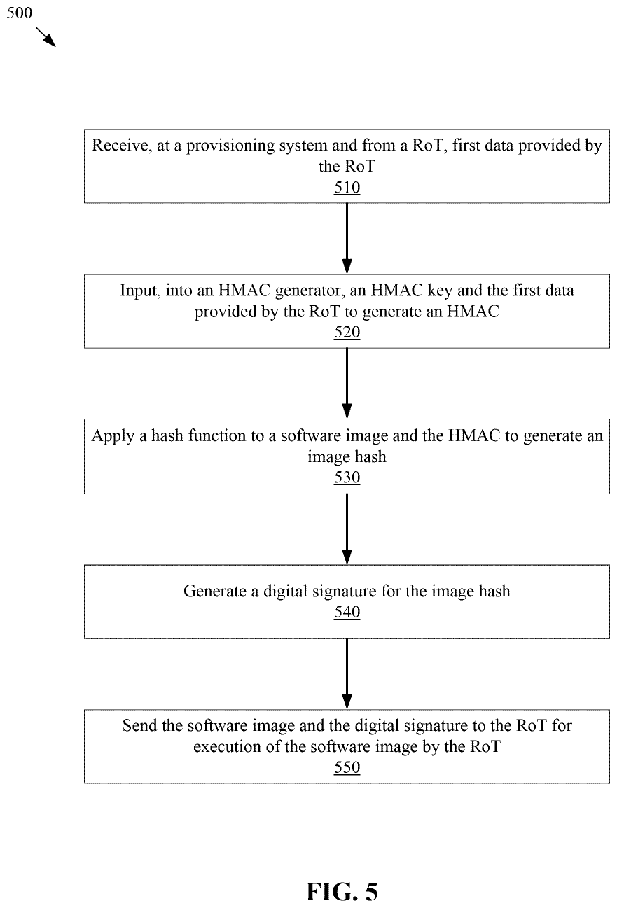

FIG. 5 depicts a flow diagram of an example method 500 for configuring a software image 126 to be replay-protected or device-bound, in accordance with some implementations of the disclosure. The individual functions, routines, subroutines, or operations of the method 500 may be performed by a processing device, having one or more CPU(s) and memory devices communicatively coupled to the CPU(s). In some implementations, the method 500 may be performed by a single processing thread or alternatively by two or more processing threads, each thread executing one or more individual functions, routines, subroutines, or operations of the method. The method 500 as described below may be performed by processing logic that may include hardware (e.g., a processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the operations may be modified. Thus, the illustrated implementations should be understood only as examples, and the illustrated operations may be performed in a different order, while some operations may be performed in parallel. Additionally, one or more operations may be omitted in some implementations. Thus, not all illustrated operations are required in every implementation, and other process flows are possible. In some implementations, the same, different, fewer, or greater operations may be performed. It is noted that elements of FIG. 1 may be used herein to help describe FIG. 5. In some implementations, the method 500 may be performed by the initialization subsystem 112 or the image signing subsystem 114 depicted in FIG. 1.

At operation 510, processing logic may receive, at a provisioning system 110 and from an RoT 130, first data provided by the RoT 130. The first data may include a nonce generated by the RoT 130 and RoT system information. Operation 510 may include the initialization subsystem 112 receiving the ROT nonce and a portion of the RoT system information 142, as depicted in FIG. 2B and described above.

In one implementation, the first data may further include a public key of the ROT 130. The public key of the RoT 130 may be contained within a digital certificate of the RoT 130. The public key of the RoT 130 may include the first ROT public key, as discussed above.

At operation 520, processing logic may apply an HMAC function 204 to an HMAC key and the first data provided by the RoT 130 to generate an HMAC. In some embodiments, the initialization subsystem 112 may generate the HMAC key as depicted in FIG. 2B or FIG. 3B and described above. In one embodiment where the first data includes the public key of the RoT 130, generating the HMAC key may be based on the public key of the RoT 130 and a private key of the provisioning system 110. As discussed above, this may include the initialization subsystem 112 using a key agreement protocol with the first ROT public key and the first provisioning system private key to generate the shared secret, and inputting the shared secret and the portion of the provisioning system information 122 into the key derivation function 206 to generate the HMAC key. The initialization subsystem 112 may input the HMAC key, the ROT nonce, and the portion of the RoT system information 142 into the HMAC function 204 to generate the HMAC.

At operation 530, processing logic may apply a hash function to a software image 126 and the HMAC to generate an image hash. As discussed above with regards to FIG. 2C, the image signing subsystem 114 may retrieve the software image 126 and may apply a hash function to the software image 126 and the HMAC to generate a first hash (referred to, in the method 500, as an “image hash”).

At operation 540, processing logic may generate a digital signature for the image hash. Operation 540 may include signing the image hash with a private key of the provisioning system 110. For example, as discussed above, the image signing subsystem 114 may use a provisioning system private key to digitally sign the image hash generated at operation 530. The provisioning system private key may include the second provisioning system private key discussed above in relation to FIG. 2C.

In some implementations, generating the digital signature for the image hash may include generating a digital signature for the image hash and a footer. The footer may include metadata associated with the software image 126. The metadata may include a version number of the software image 126 or a software application associated with the software image 126, a permission of the software image, or other metadata. The footer may include a public key (e.g., the provisioning system public key that corresponds to the provisioning system private key used to generate the digital signature). The footer may include other data. The footer may be appended to the image hash. Inclusion of the footer with the software image 126 when being digitally signed may help prevent a malicious actor from modifying the software image 126 after the digital signature has been generated. In some implementations, the footer data may, instead, be used as a header for the software image 126. The header may be prepended to the image hash.

At operation 550, processing logic may send the software image 126 and the digital signature to the RoT 130 for execution of the software image 126 by the RoT 130. In an implementation using a footer or header with the image hash, operation 550 may further include sending the header or footer to the RoT 130.

In some implementations, the method 500 further includes processing logic for transmitting, to the RoT 130, second data provided by the provisioning system 110. The second data may include a cryptographic key identifier. The second data may include a digital certificate that includes a public key of the provisioning system 110. The second data may include provisioning system information, which may include a portion of the provisioning system information 122. The second data may include a provisioning system nonce. As discussed above in relation to FIG. 2A and FIG. 3A, the initialization subsystem 112 may send the cryptographic key identifier, digital certificate, provisioning system information 122, or the provisioning system nonce.

In some implementations, the software image 126 being device-bound may include the software image 126 being device-bound to a class of devices and not just the RoT 130. To achieve this, the first data may include data identifying a class of computing devices, and a computing device that executes the RoT 130 may belong to that class of computing devices. As an example, the first data may include a portion of the RoT system information 142, and the portion of the RoT system information 142 may include information associated with the class of computing devices to which the RoT 130 belongs. Such information may include an OEM identifier, data that is unique to that class of computing devices and that is located on those computing devices, or some other type of information.

In some implementations, it may not be desirable that the software image 126 be device-bound, but it may be desirable that the software image 126 is replay-protected. In such implementations, the RoT operation subsystem 132 may not use the portion of ROT system information 142 to generate the HMAC. The RoT operation subsystem 132 may not send the portion of ROT system information 142 to the initialization subsystem 112 for the initialization subsystem 112 to use to generate the HMAC.

In one or more implementations, the provisioning system 110 may not be desirable that the software image 126 be replay-protected, but it may be desirable that the software images 126 is device-bound. In such implementations, the RoT operation subsystem 132 may not use the RoT nonce to generate the HMAC. The RoT operation subsystem 132 may not send the RoT nonce to the initialization subsystem 112 to use to generate the HMAC.

In some implementations, the RoT operation subsystem 132 may use a counter to generate a value that the RoT operation subsystem 132 may use instead of the ROT nonce. The counter may increment the generated value each time the counter is used such that the counter does not generate any values that it has generated previously. In other implementations, the ROT operation subsystem 132 may use some other operation or mechanism to generate a value to use in place of the ROT nonce that would be difficult for the RoT operation subsystem 132 to generate again.

In one implementation, the architecture 100 may use an authentication code other than an HMAC. The architecture 100 may generate the authentication code using some other operation or algorithm other than an HMAC function 204, 208. The operation or algorithm may be deterministic such that inputting matching data may result in the same output.

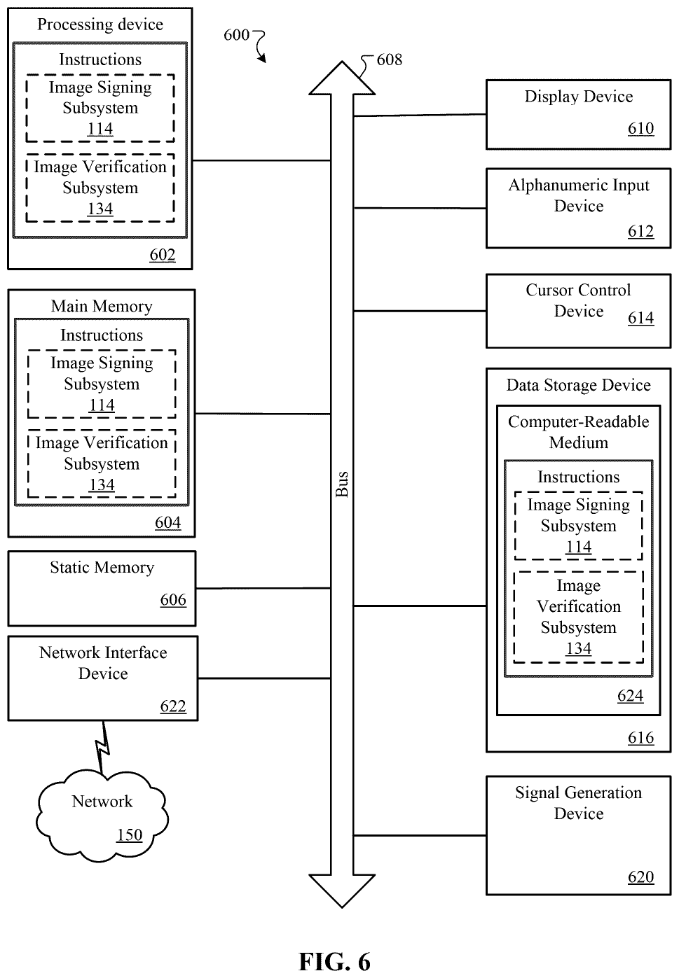

FIG. 6 is a block diagram illustrating an example computer system 600, in accordance with some implementations of the disclosure. The computer system 600 executes one or more sets of instructions that cause the machine to perform any one or more of the methodologies discussed herein. The terms “set of instructions,” “instructions,” and the like may refer to instructions that, when executed by the computer system 600, cause the computer system 600 to perform one or more operations of the provisioning system 110 or the RoT 130. The machine may operate in the capacity of a server or a client device in a client-server network environment, or as a peer machine in a peer-to-peer (or distributed) network environment. The machine may be a personal computer (PC), a tablet PC, a set-top box (STB), a personal digital assistant (PDA), a mobile telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute the sets of instructions to perform any one or more of the methodologies discussed herein. The instructions can include the initialization subsystem 112, the image signing subsystem 114, the key derivation function 206, or the HMAC function 208 of the provisioning system 110. The instructions can include the RoT operation subsystem 132, the image verification subsystem 134, the key derivation function 202, or the HMAC function 204 of the ROT 130.

The computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage device 616, which communicate with each other via a bus 608.

The processing device 602 represents one or more general-purpose processing devices such as a microprocessor, central processing unit, or the like. More particularly, the processing device 602 may be a complex instruction set computing (CISC) microprocessor, reduced instruction set computing (RISC) microprocessor, very long instruction word (VLIW) microprocessor, or a processing device implementing other instruction sets or processing devices implementing a combination of instruction sets. The processing device 602 may also be one or more special-purpose processing devices such as an application specific integrated circuit (ASIC), a field programmable gate array (FPGA), a digital signal processor (DSP), network processor, or the like. The processing device 602 is configured to execute instructions of the architecture 100 for performing the operations discussed herein.

The computer system 600 may further include a network interface device 622 that provides communication with other machines over the network 150, discussed herein. The computer system 600 also may include a display device 610 (e.g., a liquid crystal display (LCD) or a cathode ray tube (CRT)), an alphanumeric input device 612 (e.g., a keyboard), a cursor control device 614 (e.g., a mouse), and a signal generation device 620 (e.g., a speaker).

The data storage device 616 may include a non-transitory computer-readable storage medium 624 on which is stored one or more sets of instructions of the architecture 100 embodying any one or more of the methodologies or functions described herein. The sets of instructions may also reside, completely or at least partially, within the main memory 604 and/or within the processing device 602 during execution thereof by the computer system 600, the main memory 604 and the processing device 602 also constituting computer-readable storage media. The sets of instructions may further be transmitted or received over the network 618 via the network interface device 622.

While the example of the computer-readable storage medium 624 is shown as a single medium, the term “computer-readable storage medium” may include a single medium or multiple media (e.g., a centralized or distributed database, and/or associated caches and servers) that store one or more of the sets of instructions. The term “computer-readable storage medium” may include any medium that is capable of storing, encoding or carrying a set of instructions for execution by the machine and that cause the machine to perform any one or more of the methodologies of the disclosure. The term “computer-readable storage medium” may include, but not be limited to, solid-state memories, optical media, and magnetic media.

In the foregoing description, numerous details are set forth. It will be apparent, however, to one of ordinary skill in the art having the benefit of this disclosure, that the disclosure may be practiced without these specific details. In some instances, well-known structures and devices are shown in block diagram form, rather than in detail, in order to avoid obscuring the disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It may be borne in mind, however, that all of these and similar terms are to be associated with the appropriate physical quantities and are merely convenient labels applied to these quantities. Unless specifically stated otherwise, it is appreciated that throughout the description, discussions utilizing terms such as “authenticating,” “providing,” “receiving,” “obtaining,” “identifying,” “determining,” “sending,” “enabling,” or the like, refer to the actions and processes of a computer system, or similar electronic computing device, that manipulates and transforms data represented as physical (e.g., electronic) quantities within the computer system memories or registers into other data similarly represented as physical quantities within the computer system memories or registers or other such information storage, transmission or display devices.

The disclosure also relates to an apparatus for performing the operations herein. This apparatus may be specially constructed for the required purposes, or it may include a general-purpose computer selectively activated or reconfigured by a computer program stored in the computer. Such a computer program may be stored in a computer readable storage medium, such as, but not limited to, any type of disk including a floppy disk, an optical disk, a compact disc read-only memory (CD-ROM), a magnetic-optical disk, a read-only memory (ROM), a random access memory (RAM), an erasable programmable read-only memory (EPROM), an electrically erasable programmable read-only memory (EEPROM), a magnetic or optical card, or any type of media suitable for storing electronic instructions.

The word “example” or similar terms are used herein to mean serving as an example, instance, or illustration. Any aspect or design described herein as “example” is not necessarily to be construed as preferred or advantageous over other aspects or designs. Rather, use of the word “example” or other similar wording is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims may generally be construed to mean “one or more” unless specified otherwise or clear from context to be directed to a singular form. Moreover, use of the term “an implementation” or “one implementation” or “an implementation” or “one implementation” throughout is not intended to mean the same implementation or implementation unless described as such. The terms “first,” “second,” “third,” “fourth,” etc. as used herein are meant as labels to distinguish among different elements and may not necessarily have an ordinal meaning according to their numerical designation.

For simplicity of explanation, methods herein are depicted and described as a series of acts or operations. However, acts in accordance with this disclosure may occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

In additional implementations, one or more processing devices for performing the operations of the above-described implementations are disclosed. Additionally, in implementations of the disclosure, a non-transitory computer-readable storage medium stores instructions for performing the operations of the described implementations. Also in other implementations, systems for performing the operations of the described implementations are also disclosed.

It is to be understood that the above description is intended to be illustrative, and not restrictive. Other implementations will be apparent to those of skill in the art upon reading and understanding the above description. The scope of the disclosure may, therefore, be determined with reference to the appended claims, along with the full scope of equivalents to which such claims are entitled.

What is claimed is:

1. A method comprising:
obtaining, from a provisioning system, a software image and a digital signature associated with the software image;
applying a hash function to the software image and a hash message authentication code (HMAC) to generate a hash of the software image, wherein the HMAC comprises an authentication code derived from first data provided by a root of trust (RoT);
verifying, using a first public key of the provisioning system, the digital signature; and
responsive to the verification of the digital signature, causing the software image to execute.

2. The method of claim 1, wherein the first data comprises:
a first nonce generated by the RoT; and
RoT system information.

3. The method of claim 1, further comprising sending the first data to the provisioning system.

4. The method of claim 1, further comprising:
obtaining second data provided by the provisioning system;
generating an HMAC key derived from at least a portion of the second data; and
generating, based on the HMAC key and the first data, the HMAC.

5. The method of claim 4, wherein the second data comprises:
a second nonce generated by the provisioning system; and
provisioning system information.

6. The method of claim 4, wherein:
the second data comprises a cryptographic key identifier; and
generating the HMAC key further comprises:
obtaining a cryptographic key indicated by the cryptographic key identifier, and
inputting the cryptographic key and the at least a portion of the second data into a key derivation function.

7. The method of claim 4, wherein:
the second data comprises a digital certificate that includes a second public key of the provisioning system; and
generating the HMAC key further comprises:
using the second public key to compute a shared secret with the provisioning system, and
inputting the shared secret and the at least a portion of the second data into a key derivation function.

8. A system, comprising:
a memory device; and
a processing device, coupled to the memory device, to perform operations, comprising:
obtaining, from a provisioning system, a software image and a digital signature associated with the software image;
applying a hash function to the software image and a hash message authentication code (HMAC) to generate a hash of the software image, wherein the HMAC comprises an authentication code derived from first data provided by a root of trust (ROT);
verifying, using a first public key of the provisioning system, the digital signature; and
responsive to the verification of the digital signature, causing the software image to execute.

9. The system of claim 8, wherein the software image comprises a software application configured to write an original equipment manufacturer (OEM) identifier to an electronic device.

10. The system of claim 8, wherein the software image comprises a software application that includes debug enablement.

11. The system of claim 8, wherein:
the software image is encrypted; and
the operations further comprise decrypting the encrypted software image.

12. The system of claim 8, wherein:
the first data comprises data identifying a class of computing devices; and
a computing device that executes the ROT belongs to the class of computing devices.

13. The system of claim 8, wherein the first data comprises a nonce generated by the RoT.

14. The system of claim 8, wherein causing the software image to execute comprises executing the software image in the RoT.

15. A method, comprising:
receiving, at a provisioning system and from a root of trust (RoT), first data comprising a nonce generated by the ROT and ROT system information;
inputting, into a hash message authentication code (HMAC) function, an HMAC key and the first data provided by the RoT to generate an HMAC;
applying a hash function to a software image and the HMAC to generate an image hash;
generating a digital signature for the image hash; and
sending the software image and the digital signature to the RoT for execution of the software image by the RoT.

16. The method of claim 15, further comprising transmitting, to the ROT, second data provided by the provisioning system, wherein the second data comprises a cryptographic key identifier and provisioning system information.

17. The method of claim 15, wherein generating the digital signature for the image hash comprises signing the image hash with a private key of the provisioning system.

18. The method of claim 15, wherein:
the first data further comprises a public key of the RoT; and
the method further comprises generating the HMAC key based on the public key of the ROT and a private key of the provisioning system.

19. The method of claim 15, wherein:
sending the software image and the digital signature to the RoT further comprises sending a footer to the RoT, wherein the footer comprises metadata associated with the software image; and
the digital signature comprises a digital signature for the image hash and the footer.

20. The method of claim 15, wherein the software image comprises a cryptographic key-generating software application.
